(19) United States
(12) Patent Application Publication
(10) Pub. No.: US 2005/0006549 A1
(43) Pub. Date: Jan. 13, 2005

(54) Suspending structure for ceiling fan

(76) Inventor: Ching Wen Liu, Feng Yuan City (TW)

Correspondence Address: CHARLES E. BAXLEY, ESQ., 90 JOHN STREET, THIRD FLOOR, NEW YORK, NY, 10038, US

(21) Appl. No.: 10/616,739

(22) Filed: Jul. 9, 2003

(51) Int. Cl. B42F 13/00

(52) U.S. Cl. 248/343

(57) ABSTRACT

A suspending structure for ceiling fan can be installed to non-level wall surface, which includes a C-shape ring defined with an inner arc surface with a predetermined height and a canopy formed with a slot sized for permitting 45 swinging angle of the downrod, thereby the suspending structure of the present invention can truly be installed on a non-level wall surface with the downrod swingingly suspended thereof. Furthermore, the suspending structure of the present invention is also capable of securely positioning the ceiling fan by virtue of a limiter disposed outside of the gap of the mounting bracket for purpose of preventing the disengagement of the downrod in case of operation.

### BACKGROUND OF THE INVENTION

1. Field of the Invention

The present invention relates to a suspending structure for ceiling fan, and more particularly to a suspending structure for self-concentering type of ceiling fan, which comprises a C-shape ring provided with an inner arc surface with a predetermined height, a limiter and a canopy defined with a gap for permitting swinging angle of 45 degree of the downrod, whereby the suspending structure of the present invention not only can be disposed to non-level wall surface, but also capable of firmly positioning the ceiling fan in case that the mounting bracket is fixed to a non-level surface.

2. Description of the Prior Arts

A conventional suspending structure of ceiling fan normally comprises a downrod, mounting bracket and a canopy. The downrod has an arc member defined at the top end thereof for engaging in a central hole of the mounting bracket so as to cause a self-concentering effect. On the canopy a through hole is defined for passage of the downrod. Such kind of suspending structure for ceiling fan has been sold in market and applied by the customers for a long time, however, there are still some disadvantages of which need to be improved as follows:

First, when the user need to install the ceiling fan to a non-level wall, the relative swing of the arc member will cause a weak support at a side (even no support) since the downrod is movably disposed in the hole of the mounting bracket by virtue of the arc member engaged therein, such results in instability in revolution of the downrod.

Second, the canopy is provided with a through hole in the center thereof for passage of the downrod, however, in case that the ceiling fan is installed on a non-level wall, which gives rise to a relative angular moment between the downrod and the canopy, at the moment, the central hole of the canopy will abut against the downrod, as a result, it will not only damage the related parts of the ceiling fan but also severely impede the operation of the same.

The present invention has arisen to mitigate and/or obviate the afore-described disadvantages of the conventional suspending structure for ceiling fan.

### SUMMARY OF THE INVENTION

The primary object of the present invention is to provide a suspending structure for ceiling fan that can be installed on non-level wall, which includes a C-shape ring defined with an inner arc surface with a predetermined height and a canopy formed with a slot sized for permitting 45 degree swinging angle of the downrod, thereby the suspending structure of the present invention can truly be installed on a non-level wall surface with the downrod swingingly suspended thereof.

The secondary object of the present invention is to provide a suspending structure for ceiling fan that capable of securely positioning the ceiling fan by virtue of a limiter disposed outside of the gap of the mounting bracket for purpose of preventing the disengagement of the downrod in case of operation.

The present invention will become more obvious from the following description when taken in connection with the accompanying drawings, which shows, for purpose of illustrations only, the preferred embodiments in accordance with the present invention.

### BRIEF DESCRIPTION OF THE DRAWINGS

FIG. 1 is an exploded view of a suspending structure of the present invention for ceiling fan;

FIG. 2 is a side view of showing the suspending structure for ceiling fan in accordance with the present invention being installed on a level ceiling surface;

FIG. 3 is another side view of showing the suspending structure of the present invention for ceiling fan being installed on a slant wall;

FIG. 4 is a perspective view of a canopy of the suspending structure for ceiling fan in accordance with another embodiment of the present invention.

### DETAILED DESCRIPTION OF THE PREFERRED EMBODIMENTS

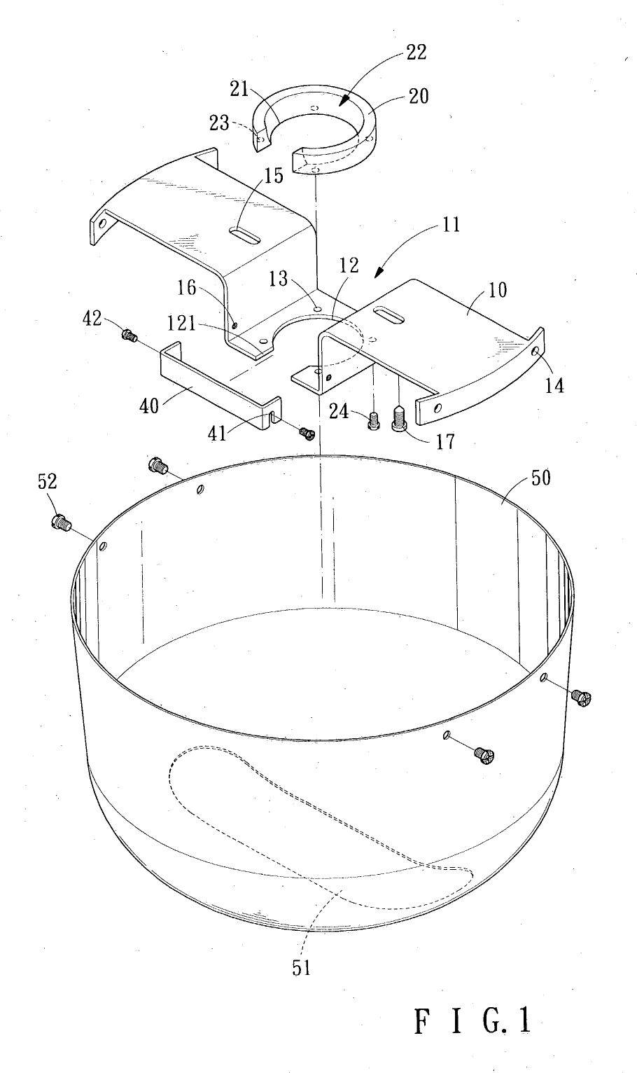

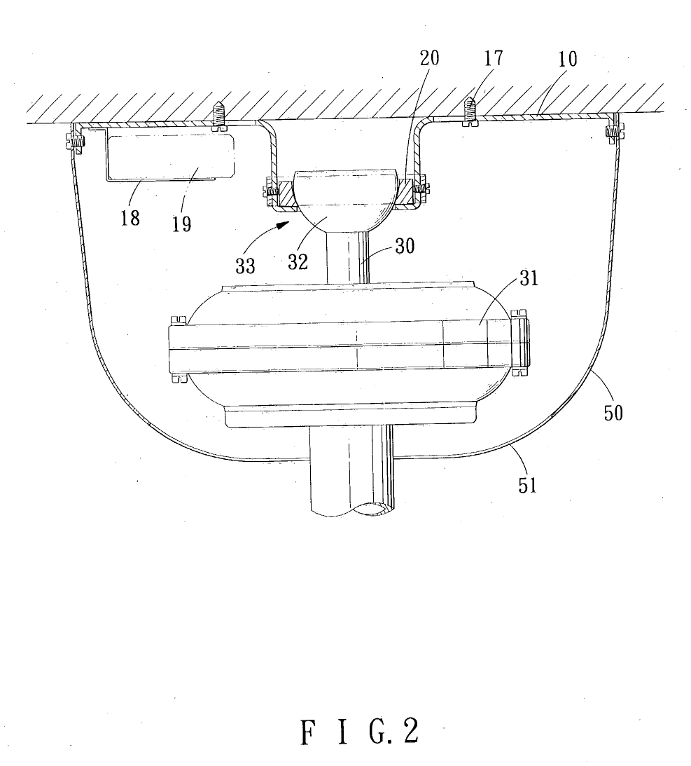

Referring to FIGS. 1-2, a suspending structure for ceiling fan in accordance with the present invention generally comprises a mounting bracket 10, a C-shape ring 20, a downrod 30, a limiter 40 and a canopy 50.

The mounting bracket 10 is provided in the center with a sunk platform 11 and at the periphery of the same is further defined with plural openings 14. The sunk platform 11 of the mounting bracket 10 has a round hole 12 formed in the center which having a gap 121 formed at a side thereof. At both sides of the gap 121 of the mounting bracket 10 is defined with a threaded hole 16 respectively and at the periphery of the hole 12 a plurality of orifices 13 are defined. Moreover, the mounting bracket 10 is further provided at the surface with plural positioning slots 15 for corresponding to wall surface, such that the mounting bracket 10 can be fixed to wall surface by cooperation of bolts 17 with the positioning slots 15.

The C-shape ring 20 is correspondingly received in the sunk platform 11 of the mounting bracket 10 and which is provided in the center with a hole 21 with corresponding to that hole 12 of the mounting bracket 10. About the periphery of the hole 21 of the C-shape ring 20 is an inner arc surface 22 with a predetermined height defined. At the bottom of the C-shape ring 20 is further provided with plural threaded holes 23, such that the C-shape ring 20 is fixed to the mounting bracket 10 by inserting screws 24 through the orifices 13 initially and then engaged in the threaded holes 23 respectively.

The downrod 30 is provided with a motor 31 of ceiling fan and its rod portion is allowed to pass through the gap 121 of the mounting bracket 10. At the top end of the downrod 30 is provided with a cupped suspending element 32 which having a bowl positive cambered surface 33 for corresponding to the inner arc surface 22 of the mounting bracket 20. By taking advantage of the engagement of the suspending element 32 in the C-shape ring 20, the downrod 30 can be swingingly positioned within a swinging angle of 45 degree.

The limiter 40 is a rod member and provided at both ends with a notch 41 respectively so as to be fixed to the mounting bracket 10 by passing screws 42 through the notches 41 initially and then engaged in the corresponding threaded holes 16 of the mounting bracket 10 respectively, the limiter 40 is then disposed outside of the gap 121.

The canopy 50 is in the shape of a cup and provided with a slot 51, through which, the canopy 50 is allowed to mounted on the dwonrod 30 and the slot 51 is sized to permit 45 degree swinging angle of the downrod 30. By virtue of the engagement of a plurality of screws 52 in the corresponding openings 14 the canopy 50 may be coupled to the mounting bracket 10.

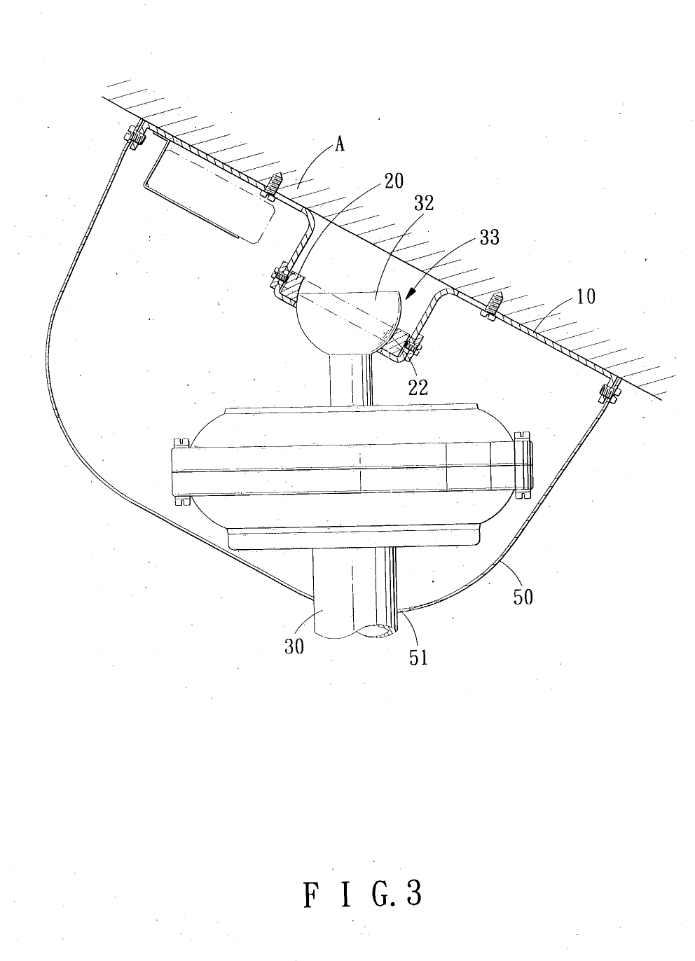

Referring to FIG. 3, in which, in case that the mounting bracket 10 is installed to a slant wall surface A by virtue of the cooperation of the bolts 17 with the corresponding positioning slots 15, the inner arc surface 22 with a predetermined height about the periphery of the hole 21 of the C-shape ring 20 will provide sufficient support for the suspending element 32 by a manner that the positive cambered surface 33 of the downrod 30 being securely and fully supported by the inner arc surface 22 of the hole 21 of the C-shape ring 20. And then the gap 121 of the mounting bracket 10 is enclosed by the limiter 40 so as to prevent disengagement of the downrod 30 from the gap 121 in case that the downrod 30 is slantingly suspended. The canopy 50 is sized for permitting swing of the downrod 30 (within swinging angle of 45 degree). Thereby, the suspending structure of the present invention for ceiling fan can truly be mounted to a non-level wall surface.

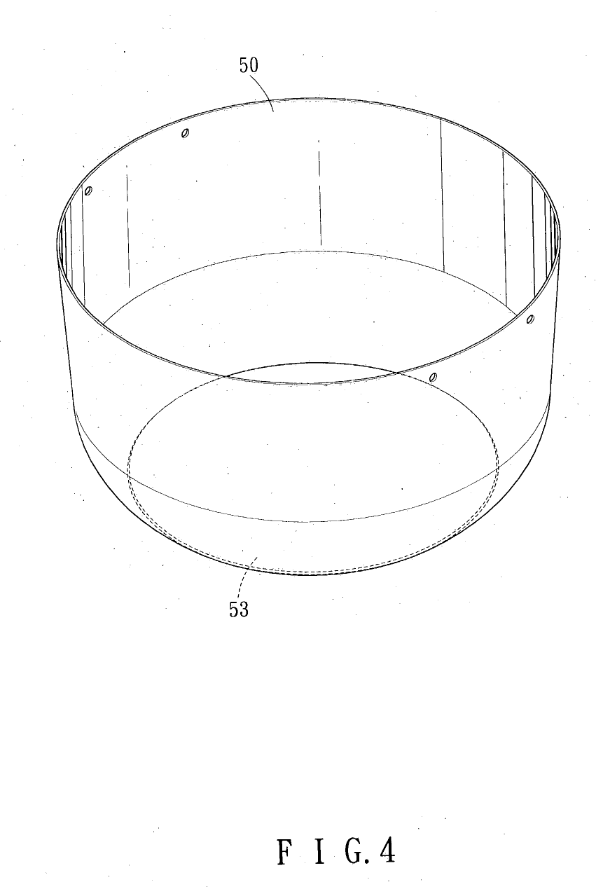

It will be noted that, with reference to FIG. 2, a holding piece 18 may further be provided on the inner surface of the mounting bracket 10 for securely positioning the control components 19 of ceiling fan. Furthermore, with reference to FIG. 4, wherein the canopy 50 can be provided with a larger round hole 53 so as to be sized for permitting swing of the downrod 30 (predetermined allowance for swinging angle is 45 degree).

While we have shown and described various embodiments in accordance with the present invention, it should be clear to those skilled in the art that further embodiments may be made without departing from the scope of the present invention.

1. A suspending structure for ceiling fan comprising:
a mounting bracket provided with a sunk platform and at the periphery of the same defined with a plurality of openings, while on the sunk platform of the mounting bracket defined with a hole having a gap formed at a side thereof, the mounting bracket employed to be fixed to wall surface;
a C-shape ring employed to be correspondingly received in the sunk platform of the mounting bracket and which provided in the center with a hole for corresponding to that of the mounting bracket, about the periphery of the hole of the C-shape ring defined with an inner arc surface with a predetermined height, the C-shape ring fixed to periphery of the mounting bracket;
a downrod provided with a motor of ceiling fan and its rod portion being able to pass through the gap of the mounting bracket, at the top end of the downrod provided with a cupped suspending element which has a bowl positive cambered surface with corresponding to the inner arc surface of the mounting bracket, by taking advantage of the engagement of the suspending element with the C-shape ring, the downrod can be swingingly positioned;
a limiter employed to fix to the mounting bracket and located at outside of the gap of the mounting bracket;
a canopy being in the shape of a cup and provided with a slot, through which, the canopy mounted on the downrod and the slot sized to permit swing of the downrod.

2. The suspending structure as claimed in claim 1, wherein the mounting bracket is provided on the inner surface with a holding piece for positioning control components of the ceiling fan.
